(19) United States
(12) Patent Application Publication
(10) Pub. No.: US 2013/0098002 A1
(43) Pub. Date: Apr. 25, 2013

(54) EXHAUST GAS TREATMENT DEVICE, METHOD FOR PRODUCING A TUBE FOR AN EXHAUST GAS TREATMENT DEVICE AND WATERCRAFT HAVING AN EXHAUST GAS TREATMENT DEVICE

(71) Applicants: Emitec Gesellschaft Fuer Emissionstechnologie MBH, Lohmar (DE); Dif Die Ideenfabrik GMBH, Tettnang (DE)

(72) Inventors: BERND DANCKERT, MECKENBEUREN (DE); SAMUEL VOGEL, BAD WALDSEE (DE)

(73) Assignees: DIF DIE IDEENFABRIK GMBH, TETTNANG (DE); EMITEC GESELLSCHAFT FUER EMISSIONSTECHNOLOGIE MBH, LOHMAR (DE)

(21) Appl. No.: 13/709,663

(22) Filed: Dec. 10, 2012

Related U.S. Application Data
(63) Continuation of application No. PCT/EP2011/058546, filed on May 25, 2011.

(30) Foreign Application Priority Data
Jun. 10, 2010 (DE) 10 2010 023 323.4

(51) Int. Cl. F02C 7/00

(52) U.S. Cl. CPC F02C 7/00
USPC 60/282; 137/561 R; 29/407.01

(57) ABSTRACT

An exhaust gas treatment device for off-road applications includes a housing having a cross-sectional area and a first wall. At least one pipe extends through the first wall and has a second wall with a perforation. The exhaust gas treatment device includes, in particular, a reducing agent supply for urea and an SCR catalytic converter. A method for producing a tube with a perforation for an exhaust gas treatment device and a watercraft having at least one exhaust gas treatment device are also provided.

### CROSS-REFERENCE TO RELATED APPLICATION

This is a continuation, under 35 U.S.C. §120, of copending International Application No. PCT/EP2011/058546, filed May 25, 2011, which designated the United States; this application also claims the priority, under 35 U.S.C. §119, of German Patent Application DE 10 2010 023 323.4, filed Jun. 10, 2010; the prior applications are herewith incorporated by reference in their entirety.

### BACKGROUND OF THE INVENTION

### Field of the Invention

The invention relates to an exhaust gas treatment device, with which the exhaust gases of an internal combustion engine can be purified. In particular, the invention relates to an exhaust gas treatment device for the “off-road” sector, that is to say, for example, an exhaust gas treatment device for a watercraft or a rail vehicle. The invention also relates to a method for producing a tube for an exhaust gas treatment device and a watercraft having an exhaust gas treatment device.

In those technical areas as well, purifying or cleaning the exhaust gases of internal combustion engines is becoming ever more important. In the diesel engine sector, and especially that of diesel engines operated with an excess of oxygen, exhaust gas purification can generally only be achieved with the aid of modern exhaust gas aftertreatment systems. In that case too, for example, the method of selective catalytic reduction (SCR), in which a reducing agent is fed to the exhaust gas in order to reduce nitrogen oxide compounds in the exhaust gas, is employed for efficient exhaust gas purification.

In contrast to the motor vehicle market, which is distinguished by high production numbers and therefore large-scale production, individual, tailor-made configurations are often demanded in the off-road sector, and especially in the watercraft market, because production numbers are considerably lower. For that reason, flexible configurations for purifying the exhaust gases of internal combustion engines are particularly important for such applications.

There is a very wide range of engine power outputs employed in watercraft and, especially, yachts. Engine power outputs range from about 250 kW [kilowatts] in the case of yachts with a length of about 10 m, for example, to engine power outputs of well above 1000 kW [kilowatts] in the case of yachts of up to more than 100 m in length. The configuration and shape of the engine compartments of watercraft of that kind often vary from one craft to another, even in the case of the same model, because it is often necessary to allow for individual buyer requirements. That also affects the development of the exhaust gas purification systems, which must be adapted to the particular requirements. For that reason, there is also a transition being made to catalytic converter systems of modular construction, the application of which to a specific watercraft can be performed quickly and without major additional development work.

In the case of installations in engine rooms of watercraft, very low surface temperatures must be maintained in some cases. In some cases, the hulls of watercraft are constructed from GRP structures (glass reinforced plastics) or CFRP structures (carbon fiber reinforced plastics). Such materials can be irreparably damaged by temperatures from only 120° C. because certain solvents in those materials evaporate out at such temperatures. In the case of exhaust gas treatment devices for watercraft, in particular yachts, particularly reliable insulation of hot components is therefore required. Moreover, provision must be made for adequate ventilation of the engine room and circulation of air around the entire system without the formation of concentrations of heat between the exhaust system and the hull.

### SUMMARY OF THE INVENTION

It is accordingly an object of the invention to provide an exhaust gas treatment device, a method for producing a tube for an exhaust gas treatment device and a watercraft having an exhaust gas treatment device, which overcome the hereinafore-mentioned disadvantages and at least partially solve the stated problems of the heretofore-known devices, methods and watercraft of this general type. In particular, an exhaust gas treatment device which is especially suitable for a watercraft will be described. Moreover, a method for producing a tube for an exhaust gas treatment device of this kind will be described.

With the foregoing and other objects in view there is provided, in accordance with the invention, an exhaust gas treatment device, comprising a housing having a cross-sectional area and a first wall, at least one tube having a second wall and extending through the first wall, the second wall having a perforation.

As used herein, the term “tube” is understood, in particular, to mean a flow conduit which is preferably rigid. Although it should be sufficient to use a (metal) cylindrical tube for many applications, this is not absolutely necessary. Thus, bent and/or (partially) flexible, tapering and/or widening tubes can also be provided. Accordingly, the at least one tube has a perforation (a multiplicity of pores, openings, holes . . . ), in particular adjoining the inlet to the exhaust gas treatment device, which leads (at least in part) to forced deflection of the flow of the exhaust gas. Through the use of this forced deflection of the flow and the suitably configured perforation, the approach flow to exhaust gas treatment components in the housing can be made more uniform. In particular, it is possible to ensure that the exhaust gas flow has a higher uniformity index at the exhaust gas treatment components. The uniformity index of a flow is calculated by first of all calculating a mean flow velocity over a cross-sectional area. Deviations from this mean flow velocity are then calculated for a multiplicity of local flow velocities on the cross-sectional area and normalized with the mean flow velocity. This gives local nonuniformity indices for each particular flow velocity. The local nonuniformity indices are summed and divided by the number thereof. This gives a global nonuniformity index. From this, it is possible to calculate the uniformity index using the following formula:

$$u = 1 - \frac{ω}{2}$$

In this formula, u is the uniformity index and w is the global nonuniformity index. Overall, the uniformity index is obtained from a multiplicity of local flow velocities in accordance with the following formula:

$$u = 1 - \frac{( \frac{1}{n} {\sum }_{i = 1}^{n} \frac{{v}_{i} - \overline{v}}{\overline{v}} )}{2}$$

In this formula, vᵢ represents the local flow velocities. If possible, the local flow velocities used to calculate the uniformity index are distributed as uniformly as possible over the cross-sectional area to be analyzed.

In accordance with another feature of the invention, the exhaust gas treatment device is particularly advantageous if the tube has a first side and a second side, and the perforation is situated only on the first side of the tube. As a rule, the term “one side of the tube” means a segment of the circumferential surface, with the first side and the second side preferably lying opposite one another. It is furthermore preferred if the circumferential surface of the tube is divided into exactly two segments (of equal size), in which case one side has no perforation and the other side has a perforation.

In accordance with a further advantageous feature of the exhaust gas treatment device of the invention, at least one exhaust gas treatment component is disposed in the housing, and the perforation is disposed only on a first side of the tube, which faces away from the exhaust gas treatment component. In this case, it is furthermore preferred if the perforation is configured in such a way that, after emerging from the perforations, the exhaust gas performs a further deflection of the flow (e.g. due to the housing) and is then fed in a particularly uniform manner to the exhaust gas treatment component. In particular, the perforation should be configured in such a way that a uniformity index which is predominantly high for the usual operating conditions is achieved immediately before entry to the exhaust gas treatment component.

In accordance with an added particularly preferred feature of the invention, the exhaust gas treatment component includes a metal honeycomb body and/or a support surface with a catalytically active material and/or a particle deposition layer. In the case of the exhaust gas treatment components explicitly presented herein, uniform impingement by the flow of exhaust gas is particularly important to enable uniformly good purification results to be achieved over the entire exhaust gas treatment component, and hence to enable particularly small exhaust gas treatment components for the difficult situation pertaining to installation explained at the outset.

In accordance with an additional advantageous feature of the exhaust gas treatment device of the invention, the perforation is adapted to the cross-sectional area and/or the shape of the housing. This means, in particular, that the configuration, size, shape, form, type, etc. of the pores, openings, holes . . . forming the perforation is embodied differently, and takes into account the spacing and/or orientation of the perforation relative to the housing and consequently that an aligned flow of the exhaust gas is achieved. Adaptation of a similar kind can also be made to the shape, alignment and type of the tube and/or of the exhaust gas treatment components.

In accordance with yet another feature of the invention, the exhaust gas treatment device can be embodied with a feed for an additive, with it being possible to operate the additive feed through the use of a controller, which is preferably implemented in such a way that the system can manage with a minimum number of input variables from the engine. It may be sufficient to obtain information on load and engine speed through the CAN bus of the internal combustion engine of the watercraft. In particular, the exhaust gas treatment device according to the invention can also be operated in such a way that it is possible to dispense completely with information from the CAN bus of the engine of the watercraft. Closed-loop or open-loop control of the exhaust gas treatment device according to the invention is then performed solely with the information which is obtained from sensors in the exhaust gas treatment device and, if appropriate, with the signal from an air mass sensor disposed in the intake line of the internal combustion engine of the watercraft.

With the objects of the invention in view, there is also provided a method for producing a tube with a perforation for an exhaust gas treatment device according to the invention. The method comprises at least the following steps:
a) positioning the tube in the housing;
b) dividing the cross-sectional area of the housing into segments;
c) dividing the tube into longitudinal sections;
d) allocating or assigning the segments to the longitudinal sections; and
e) calculating a suitable perforation for each longitudinal section in accordance with or in dependence on the segments.

The perforation of the tube is preferably formed by a multiplicity of openings or holes in the wall of the tube. The openings or holes can be of different shapes, e.g. in the form of round bores, rectangles, squares, triangles or slots. However, it is preferred if the openings are shaped in the manner of round bores.

The openings can be produced by different production methods, e.g. drilling, punching, cutting or pressing.

The method is particularly advantageous if the total number of holes in the perforation is determined before step e), and a suitable distribution of the holes between the individual longitudinal sections of the tube is calculated in step e).

In order to carry out the method according to the invention for creating the suitable perforation in the tube, it is initially assumed that the pressure loss as the exhaust gas flows into the exhaust gas treatment device is divided into three partial pressure losses. The first partial pressure loss is the pressure loss of the internal flow in the perforated tube. The second partial pressure loss is the pressure loss as the gas flows through the perforation, and the third pressure loss is caused by the internal flow in an antechamber in the housing ahead of an exhaust gas treatment component. The first partial pressure loss and the third partial pressure loss are estimated through the use of analytical relations, e.g. through the use of the pressure loss formula for calculating flows in straight tubes.

The total mass flow is then converted for a specified number of holes in the perforation. This gives a mass flow per hole. This mass flow is used to determine the hole size. For this purpose, the analytical pressure loss formula for passage through an orifice plate is used, thereby specifying a target pressure loss for the second partial pressure loss. The required hole diameter is determined from the target pressure loss for the second pressure loss and the specified number of holes. The target pressure loss for the second pressure loss as the gas flows through the perforation is defined in such a way that the target pressure loss is the dominant pressure loss as the gas flows into the exhaust gas treatment device. The target pressure loss is preferably chosen in such a way that the target pressure loss or the second pressure loss is four times as great as the first pressure loss and the third pressure loss combined. Given these assumptions, it can be presumed that the mass flow is the same through each hole and that the backpressure at each hole is the same. As a result, it is possible to control the flow distribution in the antechamber of the exhaust gas treatment device according to the invention by the positioning of the holes on the longitudinal axis of the perforated tube. In order to determine the configuration and/or positioning of the holes on the perforated tube, the cross section of the exhaust gas treatment device is then divided along the tube into strip-shaped segments (side segments), each having an area. It is necessary for the ideal approach flow to the exhaust gas treatment component downstream of the antechamber that the flow velocities on the strips should each be identical. For this purpose, the mass flow for each segment must be scaled directly with the area of the segment. The holes of the perforation are accordingly distributed according to the areas of the segments of the cross-sectional area.

It is particularly preferred if a uniformity index of the approach flow to the exhaust gas treatment component in the exhaust gas treatment device of at least 0.9, preferably more than 0.95, is achieved through the guidance of the flow in the exhaust gas treatment device according to the invention.

These effects can also be used to ensure mixing and homogenization of an exhaust gas/additive mixture passed through the perforated tube.

With the objects of the invention in view, there is concomitantly provided a watercraft, comprising at least one internal combustion engine and at least one exhaust gas treatment device according to the invention for purifying the exhaust gases of the at least one internal combustion engine.

The particular advantages and structural features described for the exhaust gas treatment device according to the invention, the watercraft according to the invention and the method according to the invention are applicable to one another in an analogous manner.

The invention and the technical context are explained in greater detail below with reference to the figures. It should be noted that the figures show particularly preferred embodiments of the invention but the invention is not restricted thereto. Of course, it is likewise possible to combine various features from different figures in any desired manner.

Other features which are considered as characteristic for the invention are set forth in the appended claims, noting that the features indicated therein can be combined with one another as desired and that the description, especially in conjunction with the figures, indicates further embodiments.

Although the invention is illustrated and described herein as embodied in an exhaust gas treatment device, a method for producing a tube for an exhaust gas treatment device and a watercraft having an exhaust gas treatment device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a first embodiment of an exhaust gas treatment device according to the invention;

FIG. 2 is a cross-sectional view of a first embodiment of an exhaust gas treatment device according to the invention;

FIG. 3 is a cross-sectional view of a second embodiment of an exhaust gas treatment device according to the invention;

FIG. 4 is a longitudinal-sectional view of a module which can be inserted within an exhaust gas treatment device according to the invention;

FIG. 5 is a plan view of a third embodiment of an exhaust gas treatment device according to the invention; and

FIG. 6 is a plan view of a watercraft having an exhaust gas treatment device according to the invention.

### DETAILED DESCRIPTION OF THE INVENTION

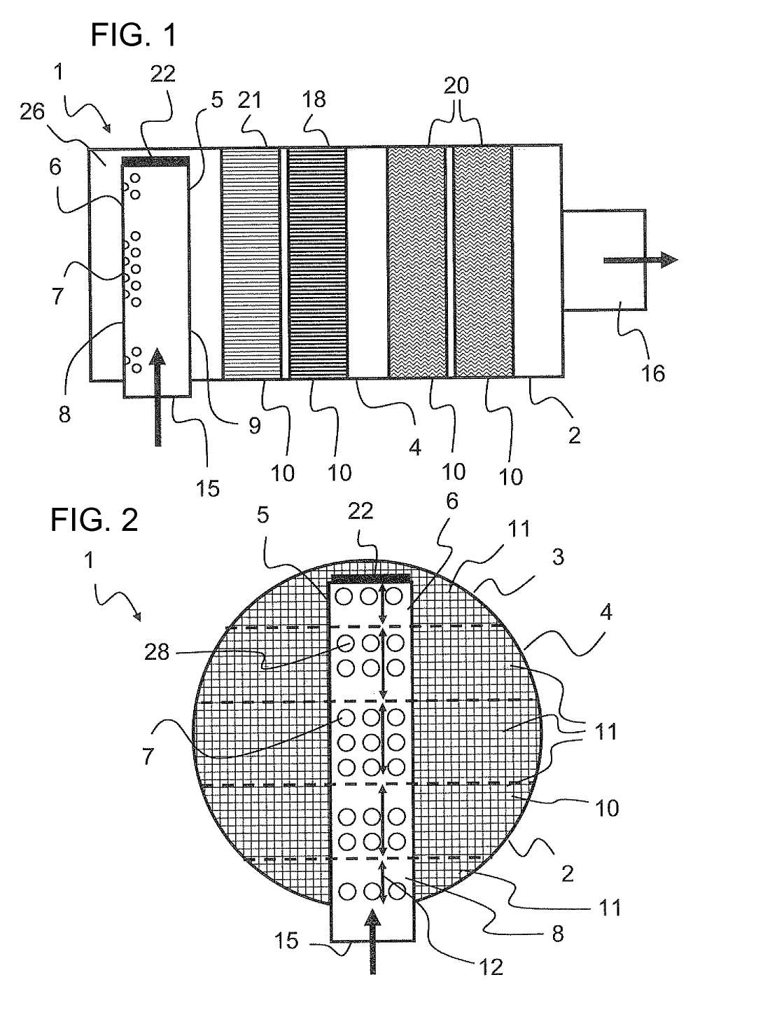

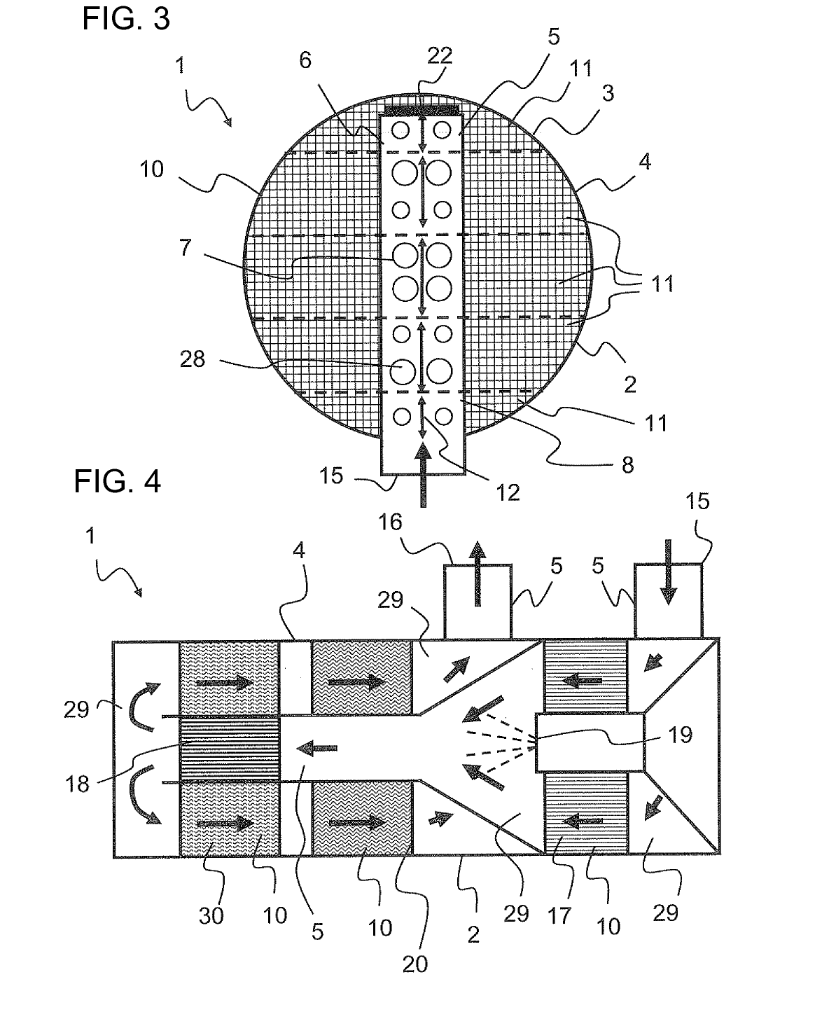

Referring now to the figures of the drawings in detail and first, particularly, to FIG. 1 thereof, there is seen an exhaust gas treatment device 1 according to the invention. The exhaust gas treatment device 1 includes a housing 2 having a cross-sectional area 3 (see FIGS. 2 and 3) and a first wall 4. A cylindrical metal tube 5 extends through the first wall 4 and has a second wall 6. The tube 5 forms an inlet 15 into the exhaust gas treatment device 1. The exhaust gas treatment device 1 furthermore has an outlet 16. An exhaust gas can flow through the exhaust gas treatment device 1 from the inlet 15 to the outlet 16, and elements installed therein are capable of withstanding conditions prevailing therein (by being resistant to high temperatures, corrosion, etc.). The flow through the exhaust gas treatment device 1 is indicated schematically with the aid of arrows. In the exhaust gas treatment device 1, there are, starting from the inlet 15, an antechamber 26 and a series of exhaust gas treatment components 10 one behind the other. The first exhaust gas treatment component 10 downstream of the antechamber 26 is a mixing element 21 (e.g. a honeycomb body with a multiplicity of flow deflections for the purpose of mixing partial flows in adjacent channels), which serves to mix the exhaust gases. This is followed by a hydrolysis catalytic converter 18 for converting a reducing agent fed to the exhaust gas treatment device 1 upstream of the inlet 15. An SCR catalytic converter 20 is then provided and is divided in this case into two individual exhaust gas treatment components 10.

The tube 5 extends at least partially into the antechamber 26 of the exhaust gas treatment device 1. A perforation 7 is provided in the second wall 6 of the tube 5, allowing exhaust gas entering through the inlet 15 to reach the antechamber 26. The tube 5 has a first side 8 and a second side 9. The first side 8 faces away from the first exhaust gas treatment component 10 in the exhaust gas treatment device 1. The second side 9 faces the first exhaust gas treatment component 10 in the exhaust gas treatment device 1. The perforation 7 is located only on the first side 8. An end of the tube 5 situated in the housing 2 has a stopper 22 to make exhaust gas entering the antechamber 26 from the tube 5 flow through the perforation 7 of the tube 5.

The perforation 7 of the tube 5 can be seen in each of the cross-sectional views of a first embodiment and a second embodiment of the exhaust gas treatment device 1 according to the invention which are shown in FIGS. 2 and 3. FIGS. 2 and 3 have many common reference signs, and therefore these figures are initially explained jointly herein. In both figures, the first side 8 of the tube 5 ahead of the first exhaust gas treatment component 10 in the exhaust gas treatment device 1 can be seen. At one end, the tube 5 forms the inlet 15 into the exhaust gas treatment device 1 and, at the opposite end, it is sealed by the stopper 22. The perforation 7 of the tube 5 is adapted to the cross-sectional area 3 of the exhaust gas treatment device 1.

In order to adapt the perforation 7, the cross-sectional area 3 is divided into segments 11 whereas the tube 5 is divided into longitudinal sections 12. Each longitudinal section 12 can be allocated to one respective segment 11. In the case illustrated therein, the allocation results from the fact that the tube 5 spans the cross-sectional area 3 in one direction, and the segments 11 of the cross-sectional area 3 are each defined perpendicularly to the tube 5 or the direction of the tube. The longitudinal sections 12 are then in each case the regions of the tube 5 which lie in particular segments 11. The perforation 7 is now adapted to the segments 11 in the individual longitudinal sections 12. The perforation 7 is preferably adapted in each case to the area of the segments 11. As a rule, the perforation 7 is formed by a multiplicity of holes 28. The holes 28 also have an area. For the purpose of adapting the perforation 7 to the segments 11, the total area of the holes 28 is in each case preferably adapted to the area of the segments 11. The total area of the holes 28 in each longitudinal section 12 is preferably in each case proportional to the area of the associated segment 11. In order to achieve this, the number of holes 28 which form the perforation 7 in FIG. 2 is adapted in the individual longitudinal sections 12 of the tube 5. In FIG. 3, the size of the individual holes 28 of the perforation 7 is additionally adapted. This represents an alternative for the adaptation of the number of holes. The adaptation of the number of holes and the adaptation of the size of the holes can also be combined within the scope of the invention.

FIG. 4 shows a special exhaust gas treatment device 1, which can be used to particular advantage within an exhaust gas treatment system together with an exhaust gas treatment device 1 according to the invention. Nevertheless, an exhaust gas treatment device 1 of this kind may also constitute an invention independently of the configuration of the tube (e.g. without a perforation).

This exhaust gas treatment device 1 also has a housing 2 with an inlet 15 for the exhaust gas from an internal combustion engine and an outlet 16 for purified or cleaned exhaust gas. The exhaust gas flows through the exhaust gas treatment device 1 shown in FIG. 4 in accordance with the arrows in the figure. Starting from the inlet 15, the exhaust gas first of all flows through an annular exhaust gas treatment component 10. The exhaust gas is directed by a deflection zone 29 from the inlet 15 into the annular exhaust gas treatment component 10. The first exhaust gas treatment component 10 is an oxidation catalytic converter 17. A reducing agent feed 19 is provided within a cavity in the annular exhaust gas treatment component 10. Adjoining the exhaust gas treatment component 10 is another deflection zone 29, through which the exhaust gas is directed into a tube 5. The reducing agent feed 19 then sprays (liquid) reducing agent (e.g. an aqueous urea solution) into the deflection zone 29 downstream of the oxidation catalytic converter 17, so that mixing takes place there and is promoted, in particular, by a conical constriction. The tube 5 extends through a plurality of further annular exhaust gas treatment components 10 and into a further deflection zone 29. A hydrolysis catalytic converter 18 is also provided in the tube, preferably concentrically with the last/first exhaust gas treatment component 10, opposite the inlet 15. In the deflection zone 29 downstream of the tube 5, the exhaust gas is deflected again and, as a result, it passes through the further annular exhaust gas treatment components 10 just mentioned. The first further annular exhaust gas treatment component 10 in the direction of through flow is a particle separator 30, in particular an “open filter,” which is formed by metal corrugated foils and metal nonwovens. In this case, the metal honeycomb structure preferably has a multiplicity of deflections, thus, on one hand, enabling thorough mixing of the exhaust gas flow again and, on the other hand, promoting deposition of particles through the use of those deflections. The second further annular exhaust gas treatment component 10 forms an SCR catalytic converter 20. Finally, there follows another deflection zone 29, which guides the now purified exhaust gas toward the outlet 16 of the exhaust gas treatment device as shown in FIG. 4. The inlet 15 and the outlet 16 are each formed by a tube 5. These tubes can extend at least partially through the wall 4 of the housing 2 of the exhaust gas treatment device 1. It is possible for the tubes 5 of the inlet 15 and the outlet 16 also to be provided with a perforation in accordance with the invention discussed herein. The same applies to the tube 5 which extends through the annular exhaust gas treatment components 10, in which the perforation is provided, for example, in the region of the housing 2 opposite the inlet 15, which is constructed to project through the last exhaust gas treatment component 10.

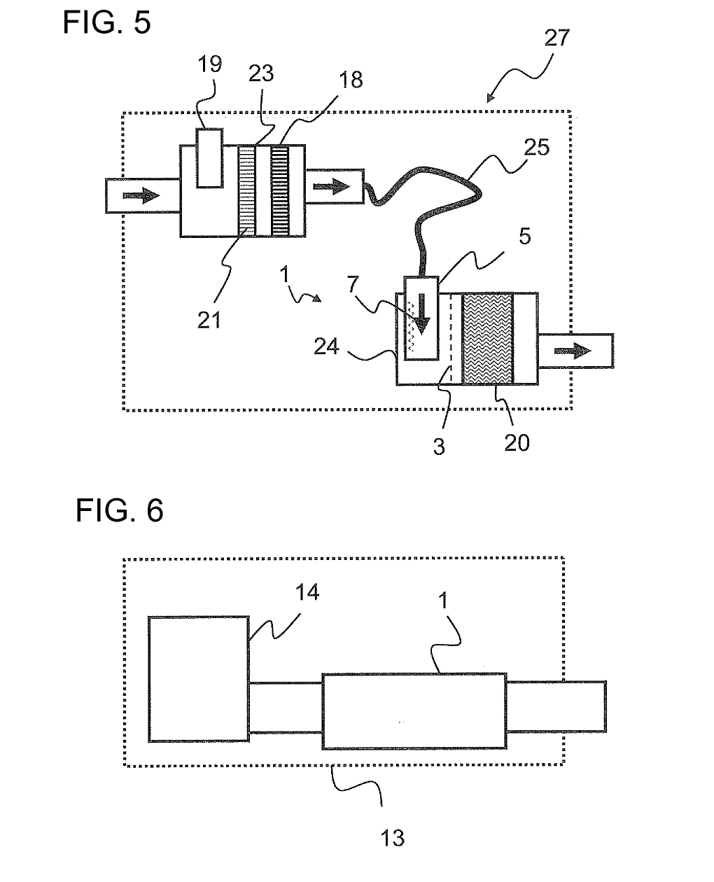

FIG. 5 shows an exhaust gas treatment system 27 which has a first module 23 and a second module 24. The exhaust gas first of all enters the first module 23 and then enters the second module 24 through a connecting line 25 of any desired shape (which can also be embodied as a tube). The flow of the exhaust gas through the first module 23 and the second module 24 is in each case indicated by arrows. In a particularly advantageous way, the second module 24 is configured as an exhaust gas treatment device 1 according to the invention having a tube 5 with a perforation 7. It is thereby possible to ensure that the exhaust gas flow modified by the desired routing of the connecting line 25 is made more uniform as it enters the second module 24 or is distributed uniformly over the cross-sectional area 3 of the second module 24. A reducing agent feed 19 (e.g. for an aqueous urea solution) is preferably provided in the first module 23. In addition, a hydrolysis catalytic converter 18 and a mixing element 21 (coated if appropriate) can additionally also be provided in the first module 23. In this way, it is possible to ensure that the exhaust gas flow leaving the first module 23 is laden in a uniform manner with completely hydrolyzed and vaporized reducing agent (ammonia). The pollutant fractions in the exhaust gas are then converted through the use of the reducing agent in the second module 24. Through the use of this embodiment, it is possible to ensure that the exhaust gas treatment system 27 for a watercraft can be adapted to the available space in the watercraft. The connecting line 25 can be adapted on an individual basis. The connecting line is preferably between 1 and 20 m long and is deflected by more than 90°, preferably more than 360°, over its total length. The guidance of the exhaust gas using the tube 5 having the perforation 7 makes it possible to at least partially restore the uniformity of an exhaust gas flow which has possibly become uneven due to the course of the connecting line 25.

FIG. 6 shows a watercraft 13 having an internal combustion engine 14 and an exhaust gas treatment device 1 according to the invention for purifying the exhaust gases of the internal combustion engine 14.

1. An exhaust gas treatment device, comprising:
a housing having a cross-sectional area and a first wall; and
at least one tube extending through said first wall;
said at least one tube having a second wall with a perforation formed therein.

2. The exhaust gas treatment device according to claim 1, wherein said at least one tube has a first side and a second side, and said perforation is disposed only at said first side of said at least one tube.

3. The exhaust gas treatment device according to claim 1, which further comprises:
at least one exhaust gas treatment component disposed in said housing;
said at least one tube having a first side facing away from said at least one exhaust gas treatment component; and
said perforation being disposed only at said first side of said at least one tube.

4. The exhaust gas treatment device according to claim 1, wherein said housing has a cross-sectional area and a shape, and said perforation is adapted to at least one of said cross-sectional area or said shape of said housing.

5. A method for producing a tube with a perforation for an exhaust gas treatment device, the method comprising the following steps:
a) positioning said tube of the exhaust gas treatment device according to claim 1 in said housing;
b) dividing said cross-sectional area of said housing into segments;
c) dividing said at least one tube into longitudinal sections;
d) allocating said segments to said longitudinal sections; and
e) calculating a suitable perforation for each of said longitudinal sections in accordance with said segments.

6. A watercraft, comprising:
at least one watercraft internal combustion engine; and
at least one watercraft exhaust gas treatment device for purifying exhaust gases of said at least one internal combustion engine of the watercraft.
